(19) United States
(12) Patent Application Publication
(10) Pub. No.: US 2013/0246578 A1
(43) Pub. Date: Sep. 19, 2013

(54) Adaptive Bit Rate Optimizations When Joining Single Profile Multicast Streams

(71) Applicant: Charles Moreman, Grayson, GA (US)

(72) Inventor: Charles Moreman, Grayson, GA (US)

(73) Assignee: Cisco Technology, Inc., San Jose, CA (US)

(21) Appl. No.: 13/421,902

(22) Filed: Mar. 16, 2012

(51) Int. Cl. G06F 15/16

(52) U.S. Cl. 709/219; 709/217; 709/231

(57) ABSTRACT

Bit rate optimization may be provided. First, fragments may be cached in a local cache. Then, a manifest file directed to a client device may be received and filtered to only contain a reference to one or more profiles corresponding to the fragments being cached in the local cache. Next, a request may be received for data corresponding to a profile in the filtered manifest. In response to the request, data fragments may then be transmitted from the local cache.

### BACKGROUND

Network efficiency and scalability of Internet Protocol (IP) Video delivery can benefit from multicast delivery of IP video packets to multiple receivers. However, multicast delivery of IP video, when compared to unicast delivery of IP video, may at times be problematic. These problems may include incompatibility with many IP video client devices and problems with multicast delivery over wireless networks.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a block diagram of an operating environment including a conversion device;

FIG. 2 is a block diagram of a conversion device; and

FIG. 3 is a flow chart of a method for providing bit rate optimization.

### DETAILED DESCRIPTION

Overview

Bit rate optimization may be provided. First, fragments may be cached in a local cache. Then, a manifest file directed to a client device may be received and filtered to only contain a reference to a profile corresponding to the fragments being cached in the local cache. Next, a request may be received for data corresponding to the profile in the filtered manifest. In response to the request, data fragments may then be transmitted from the local cache.

Both the foregoing overview and the following example embodiment are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiment.

Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Unicast Adaptive Bit Rate (ABR) video streams normally use many profiles at different bit rates and quality. Broadcast or multicast video streams are often sent using guaranteed delivery of only one profile that may correspond to only a single unicast ABR profile using the highest quality and bit rate. A problem arises when converting a single profile broadcast or multicast stream to satisfy a video client device expecting unicast. As will be discussed below, to address this problems, a multicast to unicast conversion device can filter a network manifest file to direct ABR client devices to only request a universal resource locator (URL) for ABR profiles that are being cached from a network multicast stream. This approach may at least save last mile bandwidth and improve video quality.

A content delivery system (CDS) may transmit video content to multiple client devices simultaneously. Rather than providing the video content transmission to each client device individually (e.g. unicast transmission), it may be more efficient to broadcast the video content to all of the client devices in a single video transmission (e.g. multicast transmission.) However, not all client devices are configured to receive a multicast transmission. As a result, client devices that are not compatible with multicast transmissions may need to have the multicast transmissions converted to a compatible transmission type, such as a unicast transmission, before being able to receive the video content. Accordingly, customer premise equipment (CPE) operatively tied to the client devices may comprise a conversion device (e.g. a gateway) that may be employed to convert multicast transmissions received from the CDS and provide unicast transmissions to the requesting client devices. Network devices that can convert IP video streams from multicast to unicast transmission streams (e.g. in a home) may optimize content delivery to best suit their networks, but optimal bit rate conversion can be problematic.

Consistent with embodiments of the disclosure, multicast to unicast bit rate optimization techniques may be provided. A client device that would like to receive IP video transmissions from the CDS may make a request to the conversion device to receive the content using a unicast transmission process. The conversion device may determine that the content can be received via multicast and transparently convert the multicast stream to a unicast stream so that it can be received by the client device. Specifically, the client may request to receive the unicast transmission in small IP video packets (e.g. data fragments) comprising the video content. These video packets may be requested and received by the client device in advance of their playback time at the client device. The client device may then maintain these requested video packets in a buffer to smooth out varying packet arrival latency and/or detect missing packets as quickly as possible. This, in turn, may help the client device provide an increased quality of video playback with minimal play out stalls.

Unicast Adaptive Bit Rate (ABR) video streams may be used consistent with embodiments of the disclosure. In advance of receiving data fragments, a client device may receive a manifest file. The manifest may include a plurality of profiles respectively corresponding to different bit rates and quality levels deliverable by the CDS. In other words, the CDS may pass a description of all available video profiles to the client device using the manifest file.

In response to receiving the manifest, the client device may begin requesting a given profile via unicast Hypertext Transfer Protocol (HTTP) for a specific URL that maps to this given profile. The client may either continue requesting this profile or adapt up or down (in quality) based on the client device's recent history of receiving the current video profile. For example, if the client device gets the unicast video fragments from the network with no packet loss and the video fragments arrive well in advance of when each is needed, then the client device may adapt up and begin requesting a new URL representing a next higher bit rate profile in the manifest.

The conversion device (e.g. a multicast to unicast conversion device) may be placed in the CPE (e.g. a home network) without the client device's knowledge. The highest profile stream may be available to the conversion device via multicast. The conversion device may join the multicast stream and receive the video fragments for the highest multicast stream. The conversion device may save these video fragments to its internal local cache anticipating that the client device may use them.

The client device may be working from the manifest file that describes the multiple profile streams. The client device may send requests, for example, for a Unicast URL that represents the current video profile and/or adapts to a new profile based on how well the current profile stream is being received. The client device may have no knowledge that the multicast to unicast conversion device has cached the highest bit rate stream. If the network has sufficient bandwidth and minimal latency, then the client device may adapt to the highest bit rate profile and request Unicast fragments at this highest bit rate profile. Then the conversion device may supply these Unicast requested fragments from the local cache supplied by Multicast as described above. Consequently, the “last mile” no longer has to supply the stream via unicast thus freeing bandwidth. Unfortunately, due to congestion (e.g. insufficient bandwidth and/or unacceptable latency, the client device may never adapt up to the highest bit rate profile and thus may not take advantage of the highest bit rate fragments that are already in the local cache. This may mean that the highest quality profile stream that is being cached in the conversion device may never be used and the client device may continue to request other (lower) profiles increasing the last mile bandwidth usage. In this case, video quality is lower than it could be. If the client device were able to take advantage of the fragments already in the local cache, this would clear up network congestion because the fragments that are already in the local cache are being supplied by the less bandwidth intensive multicast protocol rather than the more bandwidth intensive unicast protocol.

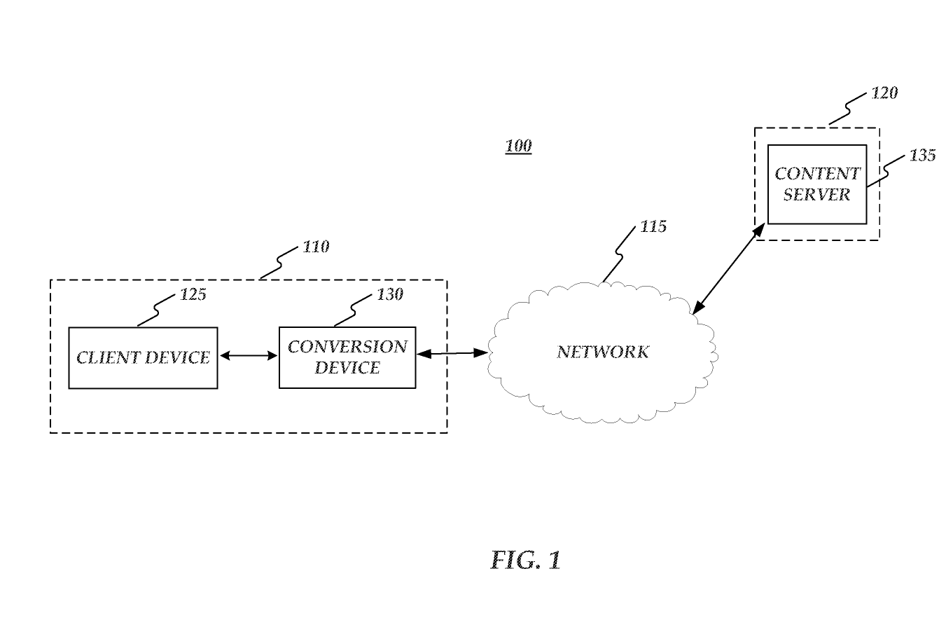

FIG. 1 is a block diagram of an operating environment 100. As shown in FIG. 1, environment 100 may include CPE devices 110, a network 115, and a CDS 120. CDS 120 may comprise a content server 135 capable of providing both a unicast and multicast transmission of content, such as IP video, to CPE devices 110. In various embodiments of the disclosure, content server 135 may comprise a separate serving device for each type of transmission. Alternatively, server may comprise a single device capable of providing both unicast and multicast content transmission.

The unicast and multicast transmissions may be communicated over network 115. Network 115 may be compatible with various communication protocols used to communicate unicast and multicast broadcasts. For example, content server 135 may communicate with CPE devices 110 over network 115 using a datagram protocol (UDP) or other protocol typically used to communicate multicast transmissions over IP or non-IP networks such as QAM based content delivery. For various other transmissions, such as unicast transmissions, content server 135 may communicate with CPE devices 110 over network 115 using Transmission Control Protocol/Internet Protocol (TCP/IP). CDS 120 may provide both multicast and unicast transmissions of the same content.

Consistent with embodiments of the disclosure, CPE devices 110 may comprise a client device 125 configured to request, receive, buffer, playback, and store, for example, content, which may be embodied in IP video packets or other data packets received either directly or indirectly from CDS 120. Client device 125 may be, but is not limited to, a Wi-Fi access point, a cellular base station, a switch servicing multiple clients in a vicinity, a tablet device, a mobile device, a mobile phone, a smart phone, a telephone, a remote control device, a set-top box, a digital video recorder, a cable modem, a personal computer, a network computer, a mainframe, a router, other similar microcomputer-based devices, or any other computing device capable of communicating with a conversion device 130 and CDS 120 over network 115. Conversion device 130 may be, but is not limited to, a Wi-Fi access point, a cellular base station, a switch servicing multiple clients in a vicinity, a tablet device, a mobile device, a mobile phone, a smart phone, a telephone, a remote control device, a set-top box, a digital video recorder, a cable modem, a personal computer, a network computer, a mainframe, a router, or other similar microcomputer-based device.

In various embodiments of the disclosure, client device 125 may only be configured to receive unicast transmissions of content. As such, in a multiple client network, the bandwidth necessary for content server 135 to satisfy multiple requests for unicast content transmissions from multiple client devices may be too burdensome or may lead to congestion on network 115. Accordingly, to reduce the burden on content server 135 or congestion on network 115, conversion device 130 may be provided within the set of CPE devices 110 for receiving content at multicast transmissions from CDS 120 and providing unicast transmission of the content to client device 125 by converting the multicast transmissions to unicast transmissions. In this way, CDS 120 may continue providing content in a multicast transmission while client device 125 may receive the content in a unicast transmission from conversion device 130.

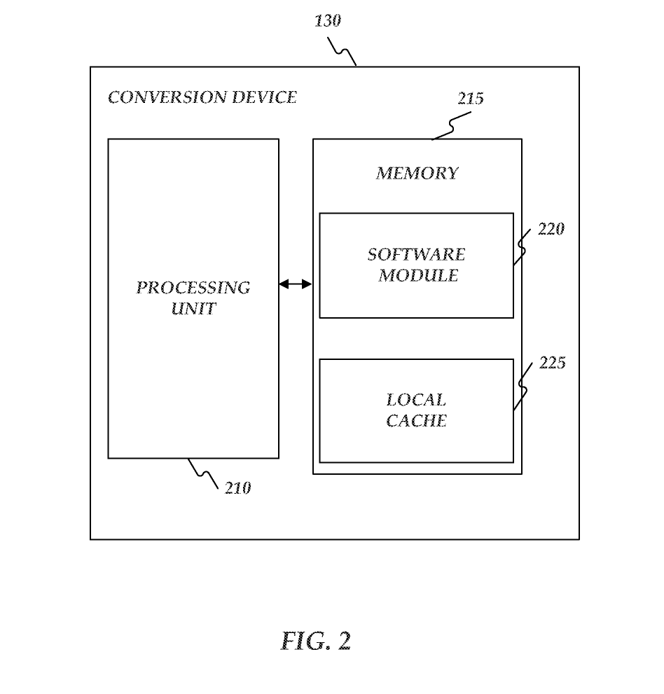

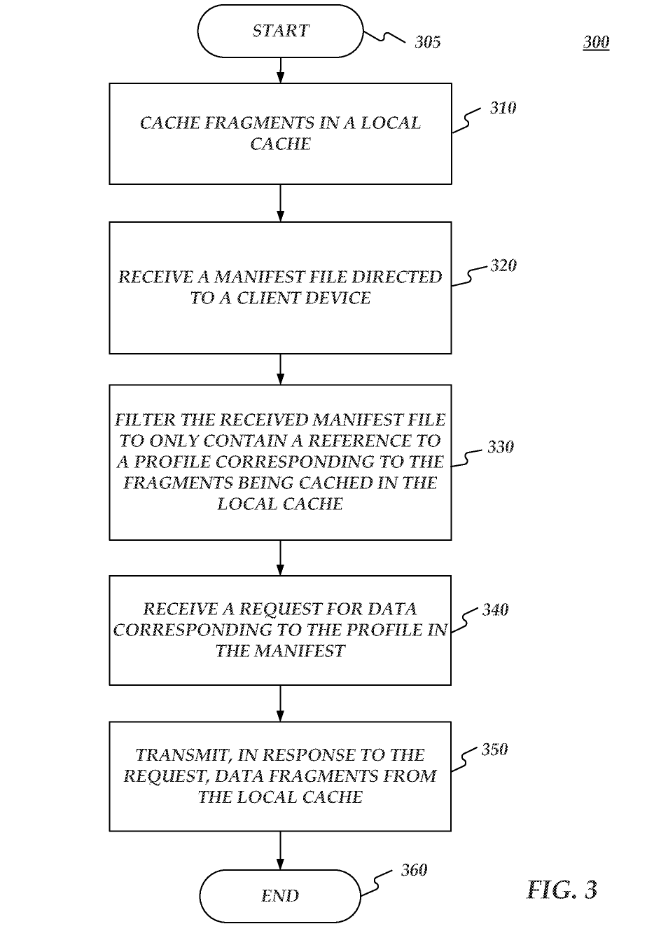

FIG. 2 shows conversion device 130 in more detail. As shown in FIG. 2, conversion device 130 may include a processing unit 210 and a memory unit 215. Memory unit 215 may include a software module 220 and a local cache 225. While executing on processing unit 210, software module 220 may perform processes for providing bit rate optimization, including for example, any one or more of the stages from method 300 described below with respect to FIG. 3.

FIG. 3 is a flow chart setting forth the general stages involved in a method 300 consistent with an embodiment of the disclosure for providing bit rate optimization. Method 300 may be implemented using conversion device 130 as described in more detail above with respect to FIGS. 1 and 2. Ways to implement the stages of method 300 will be described in greater detail below.

Method 300 may begin at starting block 305 and proceed to stage 310 where conversion device 130 may cache fragments in local cache 225. For example, conversion device 130 may be receiving fragments from content server 135 in a multicast protocol. Receiving in a multicast protocol may be more bandwidth efficient than receiving in a unicast protocol. Conversion device 130 may be receiving these fragments at the highest available quality level (e.g. suitable for a large screen high definition television.) Because conversion device 130 may be receiving fragments in a highly bandwidth efficient protocol (e.g. multicast.), it can receive the highest available quality level fragments and still be more bandwidth efficient than if it were receiving lower quality level fragments at a lower bandwidth efficient protocol (e.g. unicast.) Once received, conversion device 130 may store the received fragments in local cache 225.

In addition, conversion device 130 may intercept a device capability description from client device 125. For example, conversion device 130 may intercept the device capability description from client device 125 via HTTP tags and use the intercepted device capability description to decide which multicast stream can deliver the best profile for client device 125. So rather than choosing to receive (e.g. multicast) fragments at the highest available quality level from content server 135, conversion device 130 may choose to receive (e.g. multicast) fragments at the highest quality level consumable by client device 125. In other words, conversion device 130 may qualify client device 125's video decoding/rendering capability and use this information to decide what fragment quality level to cache. Moreover, conversion device 130 may examine the bandwidth capability between the cache point (e.g. local cache 225) and client device 125 to further qualify CPE 110's constraints that may impair client device 125's streaming capability. These constraints may include limitations of client device 125, conversion device 130, network interconnection limitations between client device 125 and conversion device 130 and other constraints.

From stage 310, where conversion device 130 caches the fragments in local cache 225, method 300 may advance to stage 320 where conversion device 130 may receive a manifest file directed to client device 125. For example, before client device 125 receives content from content server 135, content server 135 may send client device 125 the manifest file over network 115. The manifest may contain a plurality of profiles (e.g. URL's) each respectively corresponding to a different quality level deliverable by content server 135. Using the ABR process, client device 125 may use various profiles in the manifest based on congestion in network 115 (e.g. in the “last mile” of network 115 that feeds CPE 110.) However, due to congestion in network 115, client device 125 may never work its way up in the ABR process to the quality level of fragments that conversion device 130 has already cached and is readily available to client device 125. Because conversion device 130 may act as a “gateway” (e.g. a home router gateway) for CPE 110 that includes client device 125, conversion device 130 may intercept the manifest file directed to client device 125.

Once conversion device 130 receives the manifest file directed to client device 125 in stage 320, method 300 may continue to stage 330 where conversion device 130 may filter the received manifest file to only contain a reference to a profile corresponding to the fragments being cached in local cache 225. For example, once it has the manifest file, conversion device 130 may filter the manifest file to only specify the profile (e.g. URL) that it is receiving via multicast and saving to local cache 225. All other profiles (e.g. non-multicasted) may be removed from the manifest file. Conversion device 130 may then supply this filtered manifest file to the client device.

After conversion device 130 filters the received manifest file in stage 330, method 300 may proceed to stage 340 where conversion device 130 may receive a request for data corresponding to the profile in the manifest. For example, because client device 125 is working from the filtered manifest, client device 125 only has a filtered profile set to choose from; with one or more profiles corresponding to the fragments cached in local cache 225. For example the conversion device 130 may be able to receive multicast packets corresponding to two profiles. In this case the filtered manifest file would contain two profiles. A filtered profile set may consist of one or more profiles. This filtered profile set may comprise a fewer number of profiles than the original profile set received in the manifest file received from content server 135. Consequently, client device 125 may send data quests corresponding to these one or more profiles and may restrict the ABR up/down process to only profiles contained in the filtered profile set. When the filtered profile set contains only one profile the client may not use the ABR up/down process.

From stage 340, where conversion device 130 receives the request for data corresponding to the profile in the manifest, method 300 may advance to stage 350 where conversion device 130 may transmit, in response to the request, the data fragments from local cache 225. For example, because client device 125 is working from the filtered manifest, client device 125 may make requests (e.g. unicast requests) to the profile (e.g. URL) for which fragments have already been cached locally in local cache 225. Consequently, bandwidth on network 115 is not consumed with this more bandwidth intensive (e.g. unicast) request. Instead, fragments that can satisfy this request are already available at CPE 110 and were supplied to CPE 110 (e.g. local cache 225) via a less bandwidth intensive protocol (e.g. multicast.) This approach may at least save last mile bandwidth and improve video quality. Once conversion device 130 transmits the data fragments from local cache 225 in stage 350, method 300 may then end at stage 360.

An embodiment consistent with the disclosure may comprise a system for providing bit rate optimization. The system may comprise a memory storage and a processing unit coupled to the memory storage. The processing unit may be operative to cache fragments in a local cache and receive a manifest file directed to a client device. In addition, the processing unit may be operative to filter the received manifest file to only contain a reference to a profile corresponding to the fragments being cached in the local cache. Moreover, the processing unit may be operative to receive a request for data corresponding to the profile in the manifest and transmit, in response to the request, data fragments from the local cache.

Another embodiment consistent with the disclosure may comprise a system for providing bit rate optimization. The system may comprise a memory storage and a processing unit coupled to the memory storage. The processing unit may be operative to cache fragments in a local cache and intercept a manifest file directed to a client device. Furthermore, the processing unit may be operative to filter the received manifest file to only contain a reference to one or more profiles corresponding to the fragments being cached in the local cache and send the filtered manifest to the client device.

Yet another embodiment consistent with the disclosure may comprise a system for providing bit rate optimization. The system may comprise a memory storage and a processing unit coupled to the memory storage. The processing unit may be operative to intercept a manifest file directed to a client device and filter the intercepted manifest file to only contain a reference to a profile corresponding to fragments being cached in a local cache in the memory storage. In addition, the processing unit may be operative to receive a request, from the client device, for data corresponding to the profile in the manifest and transmit, in response to the request, data fragments from the local cache to the client device.

Various parts of the present disclosure refer to multicast and unicast transmissions of video content. Embodiments of the disclosure may be employed for optimizing bit rates of various content types of various transmission protocols and are not limited to multicast and/or unicast protocols.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
caching fragments in a local cache;
receiving a manifest file directed to a client device;
filtering the received manifest file to contain a reference to one or more profiles corresponding to the fragments being cached in the local cache;
receiving a request for data corresponding to a profile in the manifest file; and
transmitting, in response to the request, data fragments from the local cache.

2. The method of claim 1, wherein receiving the manifest file comprises receiving the manifest file in response to the client device requesting content.

3. The method of claim 1, wherein receiving the manifest file comprises receiving the manifest file from a server.

4. The method of claim 1, wherein receiving the manifest file comprises receiving the manifest file from a server in response to the client device requesting the manifest file from the server.

5. The method of claim 1, wherein receiving the manifest file comprises receiving the manifest file comprising a plurality of profiles.

6. The method of claim 1, wherein filtering the received manifest file to only contain the reference to one or more profiles corresponding to the fragments being cached in the local cache comprises:
determining that the fragments are being one of the following: cached in the local cache and will be cached in the local cache; and
filtering the received manifest file in response to determining that the fragments are being one of the following: cached in the local cache and will be cached in the local cache.

7. The method of claim 1, wherein caching the fragments in the local cache comprises caching the fragments received in one or more multicast protocols whereas the multicast protocol may be IP based or non-IP based.

8. The method of claim 1, wherein caching the fragments in the local cache comprises:
intercepting a device capability description from the client device; and
selecting a multicast stream from which to cache fragments in the local cache based on the intercepted device capability description.

9. The method of claim 8, wherein intercepting the device capability description comprises intercepting Hypertext Transfer Protocol (HTTP) tags corresponding to the client device.

10. The method of claim 8, wherein selecting the multicast stream comprises selecting the multicast stream that can deliver a best profile for the client device.

11. The method of claim 1, wherein caching the fragments in the local cache comprises:
examining a bandwidth between the local cache and the client device; and
selecting a multicast stream from which to cache fragments in the local cache based on the examined bandwidth.

12. The method of claim 1, further comprising sending the filtered manifest to the client device.

13. The method of claim 1, wherein transmitting, in response to the request, the data fragments from the local cache comprises transmitting the data fragments from the local cache to the client device.

14. A computer readable medium having a set of instructions which when executed performs a method executed by the set of instructions comprising:
caching fragments in a local cache;
intercepting a manifest file directed to a client device;
filtering the received manifest file to only contain a reference to a profile corresponding to the fragments being cached in the local cache; and
sending the filtered manifest to the client device.

15. The computer readable medium of claim 14, wherein caching the fragments in the local cache comprises:
intercepting a device capability description from the client device; and
selecting a multicast stream from which to cache fragments in the local cache based on the intercepted device capability description.

16. The computer readable medium of claim 14, wherein caching the fragments in the local cache comprises:
examining a bandwidth between the local cache and the client device; and
selecting a multicast stream from which to cache fragments in the local cache based on the examined bandwidth.

17. An apparatus comprising:
a memory storage; and
a processing unit coupled to the memory storage, the processing unit being configured to:
intercept a manifest file directed to a client device;
filter the intercepted manifest file to only contain a reference to a profile corresponding to fragments being cached in a local cache in the memory storage;
receive a request, from the client device, for data corresponding to the profile in the manifest; and
transmit, in response to the request, data fragments from the local cache to the client device.

18. The apparatus of claim 17, wherein the processing unit being configured to intercept the manifest file comprises the processing unit being configured to intercept the manifest file from a content server in response to the client device requesting content in a unicast protocol from the content server.

19. The apparatus of claim 17, wherein the processing unit being configured to intercept the manifest file comprises the processing unit being configured to intercept the manifest file in response to the client device requesting content.

20. The apparatus of claim 17, wherein the processing unit being configured to intercept the manifest file comprises the processing unit being configured to intercept the manifest file from a content server in response to the client device requesting content from the content server.
